(19) United States
(12) Patent Application Publication
(10) Pub. No.: US 2012/0163791 A1
(43) Pub. Date: Jun. 28, 2012

(54) Stereoscopic Imaging Device

(75) Inventors: Tatsuro Juri, Osaka (JP); Kenjiro Tsuda, Kyoto (JP); Hiroaki Shimazaki, Osaka (JP); Yuji Nagaishi, Osaka (JP); Takashi Masuno, Osaka (JP)

(73) Assignee: PANASONIC CORPORATION, Osaka (JP)

(21) Appl. No.: 13/338,283

(22) Filed: Dec. 28, 2011

(30) Foreign Application Priority Data
Dec. 28, 2010 (JP) 2010-294047
Dec. 8, 2011 (JP) 2011-269452

(51) Int. Cl. G03B 35/10

(52) U.S. Cl. 396/327

(57) ABSTRACT

A small-sized stereo-image taking apparatus that includes a small-sized beam splitter for splitting in two the imaging light from a photographic subject and that makes it possible to take both telephotographic-range and wide-angle-range images is afforded. The stereo-image taking apparatus includes: an optical element having an optically functional surface splitting in two the imaging light from a photographic subject; first and second telescopic lens barrels having telescoping functionality; first and second imaging devices mounted on the first and second telescopic lens barrels, for generating first and second images on the basis of first and second imaging light constructing images through the first and second telescopic lens barrels; and first and second moveable sections causing the first and second imaging devices to parallel-shift optical-axis-wise in accordance with extension/retraction of the first and second telescopic lens barrels.

### CROSS REFERENCE TO RELATED APPLICATION

The disclosure of Japanese Patent Application Nos. 2010-294047, filed on Dec. 28, 2010, and 2011-269452, filed on Dec. 8, 2011, is incorporated herein by reference.

### BACKGROUND OF THE INVENTION

1. Field of the Invention

The present invention relates to stereoscopic imaging devices that, employing dual imaging devices, take stereoscopically visible images, and more particularly relates to a stereo-image taking apparatus that employs dual imaging devices on which lens barrels having telescoping functionality are mounted.

2. Description of the Background Art

In a conventional stereo-image taking apparatus, imaging light from a photographic subject is split into imaging light for the left eye and imaging light for the right eye, and a left-eye imaging device and a right-eye imaging device are used to generate, from the left-eye imaging light and the right-eye imaging light, a stereoscopic image that causes a viewer to sense a stereoscopic effect.

FIG. 8 is a diagram illustrating a situation in which a stereo-image taking apparatus 900 in conventional art photographs an image of telephotographic range. In FIG. 8, the stereo-image taking apparatus 900 includes a left-eye imaging device 910, a right-eye imaging device 920, and a semi-reflective mirror 930. It should be noted that the left-eye imaging device 910 is mounted on a left-eye telescopic lens barrel 911 having telescoping functionality, and the right-eye imaging device 910 is mounted on a right-eye telescopic lens barrel 921 having telescoping functionality.

Further, in order to adjust the interval (stereo base) between the construct-image positions along the optical axes of the left-eye telescopic lens barrel 911 and the right-eye telescopic lens barrel 921, the right-eye imaging device 910 parallel-shifts horizontally and perpendicularly to the optical axis of the left-eye telescopic lens barrel 911 (in the direction to the far side of the sheet and the direction to the near side of the sheet). Japanese Patent No. 4293821 discloses technology relating to a stereo-image taking apparatus, employing a semi-reflective mirror, that allows the stereo base to be freely set.

The semi-reflective mirror 930 passes left-eye imaging light that is one portion of the imaging light from a photographic subject, and reflects right-eye imaging light that is the remaining portion of the subject imaging light. The left-eye imaging device 910 generates an image for the left eye on the basis of image-constructing imaging light for the left eye, and the right-eye imaging device 920 generates an image for the right eye on the basis of image-constructing imaging light for the right eye. In this manner, the stereo-image taking apparatus 900 in the conventional art generates, on the basis of the left-eye image and the right-eye image, a stereoscopic image that causes a viewer to sense a stereoscopic effect.

Here, in order to take an image of telephotographic range, the left-eye telescopic lens barrel 911 and the right-eye telescopic lens barrel 921 are extended, and the required region of the semi-reflective mirror 930 for ranges in which images can be taken with the left-eye telescopic lens barrel 911 and the right-eye telescopic lens barrel 921 is the region 931 as shown in FIG. 8.

FIG. 9 is a diagram illustrating a situation in which the stereo-image taking apparatus 900 in the conventional art takes an image of wide-angle range. The difference from the state shown in FIG. 8 is that in order to take an image of wide-angle range, the left-eye telescopic lens barrel 911 and the right-eye telescopic lens barrel 921 are retracted, and the required region of the semi-reflective mirror 930 for ranges in which images can be taken with the left-eye telescopic lens barrel 911 and the right-eye telescopic lens barrel 921 is the region 932 as shown in FIG. 9.

However, in the stereo-image taking apparatus 900 in the conventional art, in order to make it possible to take both images of telephotographic range and wide-angle range, the region 932 shown in FIG. 9 (>the region 931 shown in FIG. 8) is required. In other words, in the stereo-image taking apparatus 900 in the conventional art, a large-size semi-reflective mirror, which is unnecessary when an image of telephotographic range is taken, is required in order to take an image of wide-angle range. As a result, the stereo-image taking apparatus 900 is over-sized.

### SUMMARY OF THE INVENTION

Therefore, it is an object of the present invention to make available a small-sized stereo-image taking apparatus that includes a small-sized beam splitter for splitting in two the imaging light from a photographic subject and that makes it possible to take both images of telephotographic range and wide-angle range.

In order to attain the object mentioned above, a stereo-image taking apparatus of the present invention includes: an optical element having an optically functional surface passing first imaging light, being a portion of imaging light incident from a photographic-subject side thereof, and reflecting second imaging light, being the remaining portion of the incident imaging light; a first telescopic lens barrel having telescoping functionality, defining a first lens length and a first extension/retraction axis, and constructing the first imaging light into an image; a second telescopic lens barrel having telescoping functionality, defining a second lens length and a second extension/retraction axis, and constructing the second imaging light into an image; a first imaging device mounted on the first telescopic lens barrel, for generating a first image on the basis of the first imaging light constructed into an image through the first telescopic lens barrel; a second imaging device mounted on the second telescopic lens barrel, for generating a second image on the basis of the second imaging light constructed into an image through the second telescopic lens barrel; a first moveable section causing, in accordance with extension/retraction of the first telescopic lens barrel, the first imaging device to parallel-shift along the first extension/retraction axis; and a second moveable section causing, in accordance with extension/retraction of the first telescopic lens barrel, the second imaging device to parallel-shift along the second extension/retraction axis.

Typically, the distance along the optical axis of the first telescopic lens barrel from the optically functional surface to a front-most surface of the first telescopic lens barrel and the distance along the optical axis of the second telescopic lens barrel from the optically functional surface to a front-most surface of the second telescopic lens barrel are constant.

Preferably, the stereo-image taking apparatus of the present invention further includes: a first lens barrel holding member fixing the position of the front-most surface of the first telescopic lens barrel; and a second lens barrel holding member fixing the position of the front-most surface of the second telescopic lens barrel.

Further, preferably, the first moveable section moves in conjunction with the extension/retraction of the first telescopic lens barrel, and the second moveable section moves in conjunction with the extension/retraction of the second telescopic lens barrel.

Moreover, preferably, the stereo-image taking apparatus of the present invention also includes rails formed along the optical axes of the first and second telescopic lens barrels, respectively. The first and second moveable sections are shiftably carried on the respective rails.

Further, preferably, the stereo-image taking apparatus of the present invention also includes a control section controlling extent of shifting by the first and second moveable sections. The control section is configured to control the first moveable section so as to move the first imaging device to a position corresponding to the first lens length, and is configured to control the second moveable section so as to move the second imaging device to a position corresponding to the second lens length.

Further, preferably, the stereo-image taking apparatus of the present invention also includes a look-up table correlating the first lens length with the first-imaging-device position corresponding to the first lens length, and correlating the second lens length with the second-imaging-device position corresponding to the second lens length. The control section controls the first and second moveable sections on the basis of the look-up table.

As described above, according to the present invention, a small-sized prism member having an optically functional surface for splitting imaging light from a photographic subject into two portions is included and it is made possible to take both of images of telephotographic range and wide-angle range.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a situation in which a stereo-image taking apparatus 100 according to a first embodiment of the present invention takes an image of telephotographic range;

FIG. 2 is a diagram illustrating a situation in which the stereo-image taking apparatus 100 according to the first embodiment of the present invention takes an image of wide-angle range;

FIG. 3 is a diagram illustrating a situation in which a stereo-image taking apparatus 101 according to the first embodiment of the present invention takes an image of telephotographic range;

FIG. 4 is a diagram illustrating a situation in which the stereo-image taking apparatus 101 according to the first embodiment of the present invention takes an image of wide-angle range;

FIG. 5 is a diagram illustrating a situation in which a stereo-image taking apparatus 200 according to a second embodiment of the present invention takes an image of telephotographic range;

FIG. 6 is a diagram illustrating a situation in which the stereo-image taking apparatus 200 according to the second embodiment of the present invention takes an image of wide-angle range;

FIG. 7 is a diagram illustrating a stereo-image taking apparatus 300 according to a third embodiment of the present invention;

FIG. 8 is a diagram illustrating a situation in which a stereo-image taking apparatus 900 in the conventional art takes an image of telephotographic range; and

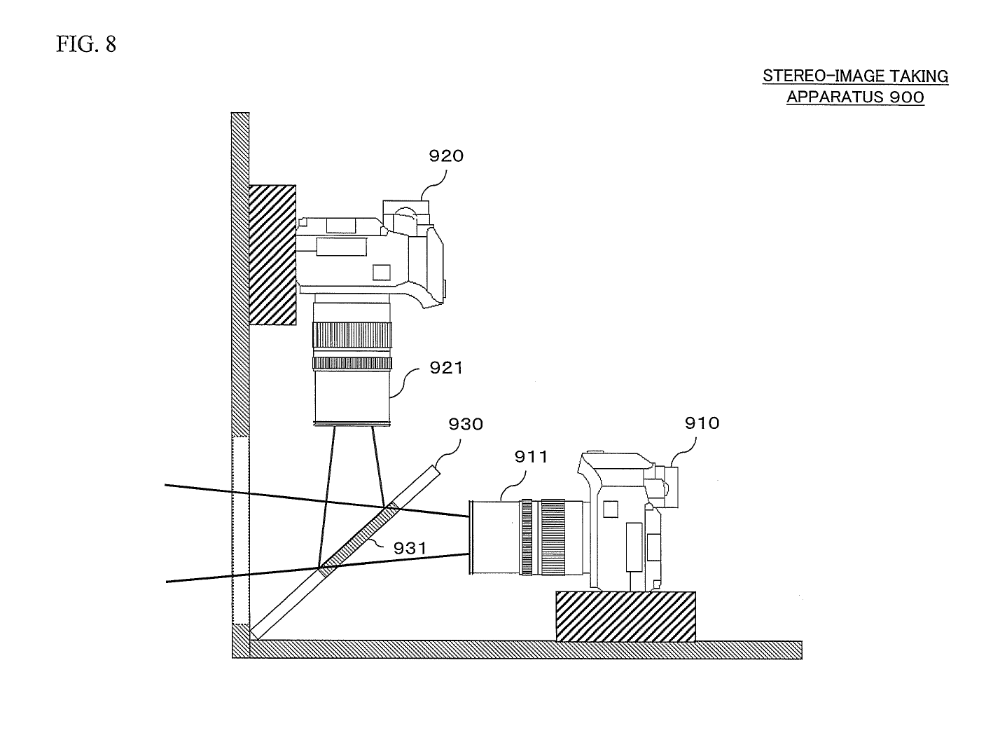

FIG. 9 is a diagram illustrating a situation in which the stereo-image taking apparatus 900 in the conventional art takes an image of wide-angle range.

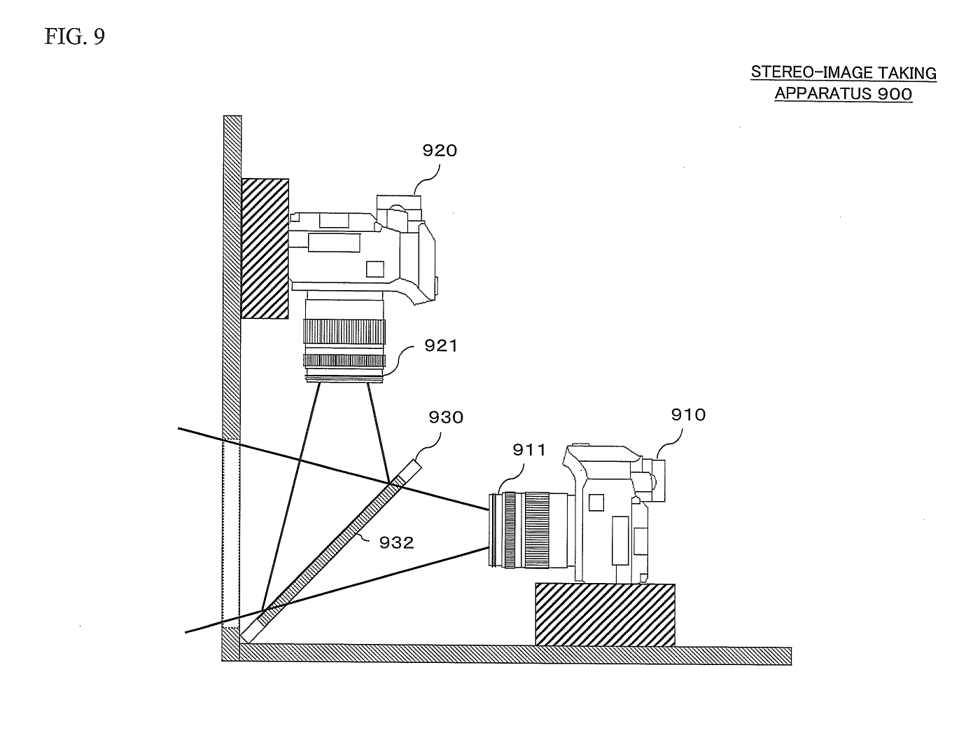

### DESCRIPTION OF THE PREFERRED EMBODIMENTS

Hereinafter, each embodiment of the present invention will be described with reference to the drawings.

### First Embodiment

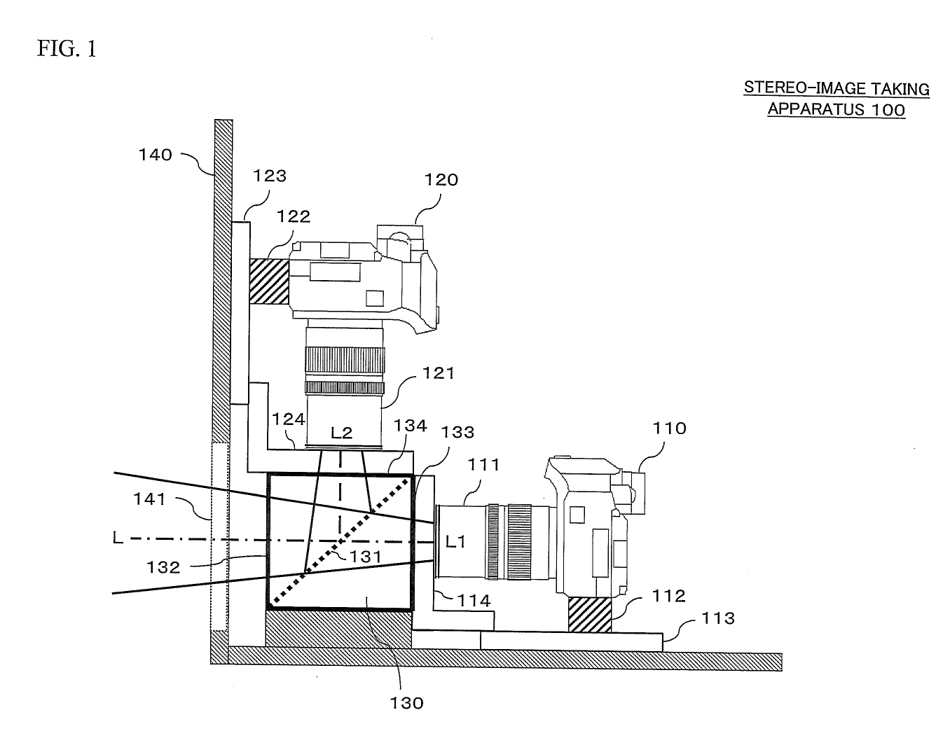

FIG. 1 is a diagram illustrating a situation in which a stereo-image taking apparatus 100 according to the first embodiment of the present invention takes an image of telephotographic range. In FIG. 1, the stereo-image taking apparatus 100 includes a first imaging device 110, a second imaging device 120, and a prism member 130. The stereo-image taking apparatus 100 is covered with a housing 140, and imaging light from a photographic subject is incident thereon through a front window 141.

It should be noted that the first imaging device 110 is mounted on a first telescopic lens barrel 111 having telescoping functionality and is retained by a first moveable section 112. The second imaging device 120 is mounted on a second telescopic lens barrel 121 having telescoping functionality and is retained by a second moveable section 122.

The first imaging device 110 is a left-eye imaging device which generates an image for the left eye, and the second imaging device 120 is a right-eye imaging device which generates an image for the right eye.

The prism member 130 is a beam splitter having an optically functional surface 131 which splits imaging light from a photographic subject, into first imaging light and second imaging light. The optically functional surface 131 is formed by, for example, a metal thin film or a dielectric multilayer film. In order to cause the intensity of the first imaging light to coincide with the intensity of the second imaging light, a semi-reflective mirror is used as the optically functional surface 131.

The imaging light from the photographic subject is incident on an incident surface 132 of the prism member 130, and the first imaging light corresponding to the viewpoint of the left eye passes through the optically functional surface 131 and is incident on the first telescopic lens barrel 111. The imaging light incident on the first telescopic lens barrel 111 constructs an image on an imaging surface of a solid-state image sensor or the like within the first imaging device 110, and is photoelectrically converted into an image signal for the left eye. In this manner, the first imaging device 110 generates an image for the left eye.

Similarly, the imaging light from the photographic subject is incident on the incident surface 132 of the prism member 130, and the second imaging light corresponding to the viewpoint of the right eye is reflected by the optically functional surface 131 and incident on the second telescopic lens barrel 121. The imaging light incident on the second telescopic lens barrel 121 constructs an imaging surface of a solid-state image sensor or the like within the second imaging device 120, and is photoelectrically converted into an image signal for the right eye. In this manner, the second imaging device 120 generates an image for the right eye.

Further, in order to adjust the interval (stereo base) between the construct-image positions along the optical axes of the first telescopic lens barrel 111 and the second telescopic lens barrel 121, the first imaging device 110 parallel-shifts horizontally and perpendicularly to the optical axis of the first telescopic lens barrel 111 (in the direction to the far side of the sheet and the direction to the near side of the sheet).

Here, when an parallax amount is excessively large or vertical shift occurs between a photographic subject image on the image for the left eye and a photographic subject image on the image for the right eye, a viewer cannot obtain a preferable stereoscopic effect when observing a stereoscopic image. Thus, it is crucial to precisely adjust the interval and parallelism between the optical axis L1 of the first telescopic lens barrel 111 and the optical axis L2 of the second telescopic lens barrel 121. In other words, an optical axis obtained by causing the optical axis L1 of the first telescopic lens barrel 111 to pass through the optically functional surface 131 and an optical axis obtained by bending the optical axis L2 of the second telescopic lens barrel 121 by the optically functional surface 131 have to coincide with each other to be an optical axis L as shown in FIG. 1, when seen from the lateral direction of the stereo-image taking apparatus 100.

In the stereo-image taking apparatus 100 according to the first embodiment of the present invention, the prism member 130 has, for example, a rectangular parallelepiped shape, and the cross section of the prism member 130 has a square shape as shown in FIG. 1, when seen from the lateral direction of the stereo-image taking apparatus 100. Within the prism member 130, the optically functional surface 131 is formed so as to precisely have an angle of 45 degrees with respect to the incident surface 132.

A first light-exit surface 133 of the prism member 130 is formed so as to be precisely parallel to the incident surface 132, for example, by polishing. In addition, a second light-exit surface 134 of the prism member 130 is formed so as to be perpendicular to the incident surface 132 and the first light-exit surface 133, for example, by polishing.

As described above, the prism member 130 is precisely formed. Thus, when the first telescopic lens barrel 111 is caused to directly face the first light-exit surface 133 and the second telescopic lens barrel 121 is caused to directly to face the second light-exit surface 134, the optical axis obtained by causing the optical axis L1 of the first telescopic lens barrel 111 to pass through the optically functional surface 131 and the optical axis obtained by bending the optical axis L2 of the second telescopic lens barrel 121 by the optically functional surface 131 can be caused to coincide with each other to be the optical axis L as shown in FIG. 1, when seen from the lateral direction of the stereo-image taking apparatus 100.

Under the optical axis adjustment described above, the position of a front-most surface of the first telescopic lens barrel 111 with respect to the first light-exit surface 133 is set and the position of a front-most surface of the second telescopic lens barrel 121 with respect to the second light-exit surface 134 is set.

A first lens barrel holding member 114 retains a front end of the first telescopic lens barrel 111 such that the front-most surface of the first telescopic lens barrel 111 is fixed at a position where the optical axis adjustment is precisely performed. Similarly, a second lens barrel holding member 124 retains a front end of the second telescopic lens barrel 121 such that the front-most surface of the second telescopic lens barrel 121 is fixed at a position where the optical axis adjustment is precisely performed.

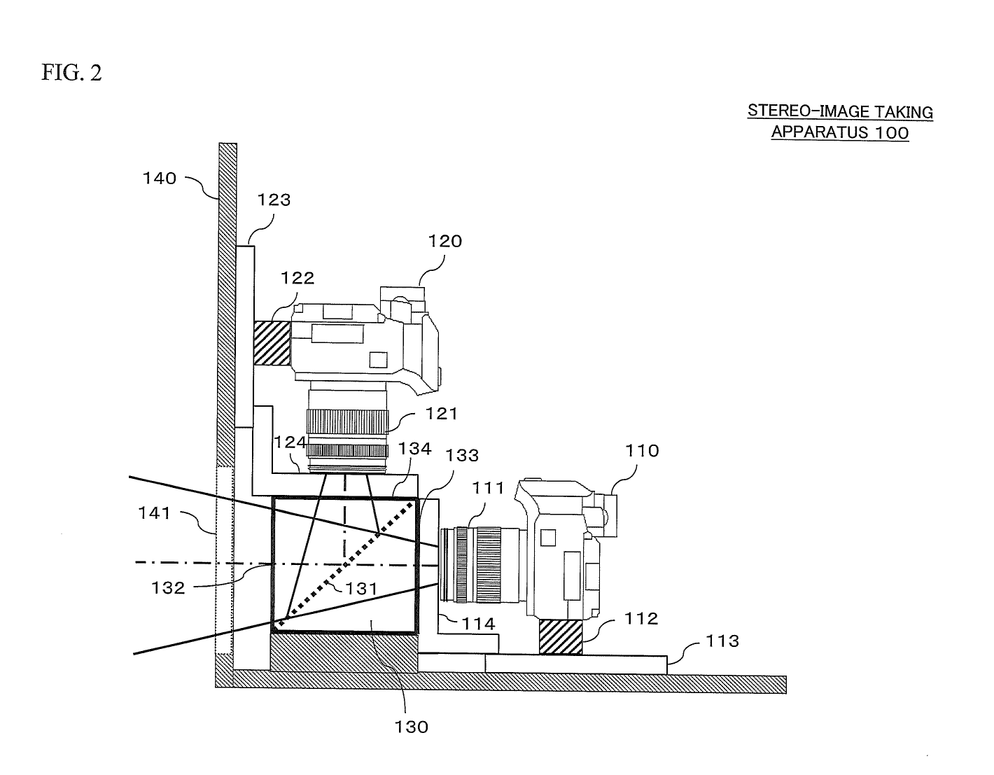

FIG. 2 is a diagram illustrating a situation in which the stereo-image taking apparatus 100 according to the first embodiment of the present invention takes an image of wide-angle range. The difference from the state shown in FIG. 1 is that in order to take an image of wide-angle range, the first telescopic lens barrel 111 and the second telescopic lens barrel 121 are retracted.

Here, in the stereo-image taking apparatus 100, the front ends of the first telescopic lens barrel 111 and the second telescopic lens barrel 121 are fixed by the first lens barrel holding member 114 and the second lens barrel holding member 124 as described with reference to FIG. 1, and thus the first imaging device 110 and the second imaging device 120 are moved as shown in FIG. 2.

Specifically, a first movement rail 113 allows movement along the optical axis direction of the first telescopic lens barrel 111 and is installed on the housing 140. The first moveable section 112 retains the first imaging device 110 and has a mechanism to move on the first movement rail 113.

When the first telescopic lens barrel 111 is retracted, the first imaging device 110 mounted on the first telescopic lens barrel 111 moves toward the front end side of the first telescopic lens barrel 111 with movement of the first moveable section 112 on the first movement rail 113, since the front end of the first telescopic lens barrel 111 is fixed by the first lens barrel holding member 114.

Further, even when the first imaging device 110 moves as described above, optical axis shift does not occur since the position of the front-most surface of the first telescopic lens barrel 111 with respect to the first light-exit surface 133 is set under the precise optical axis adjustment and the first lens barrel holding member 114 retains the front end of the first telescopic lens barrel 111.

Similarly, a second movement rail 123 allows movement along the optical axis direction of the second telescopic lens barrel 121 and is installed on the housing 140. The second moveable section 122 retains the second imaging device 120 and has a mechanism to move on the second movement rail 123.

When the second telescopic lens barrel 121 is retracted, the second imaging device 120 mounted on the second telescopic lens barrel 121 moves toward the front end side of the second telescopic lens barrel 121 with movement of the second moveable section 122 on the second movement rail 123, since the front end of the second telescopic lens barrel 121 is fixed by the second lens barrel holding member 124.

Further, even when the second imaging device 120 moves as described above, optical axis shift does not occur since the position of the front-most surface of the second telescopic lens barrel 121 with respect to the second light-exit surface 134 is set under the precise optical axis adjustment and the second lens barrel holding member 124 retains the front end of the second telescopic lens barrel 121.

It should be noted that needless to say, when the first telescopic lens barrel 111 and the second telescopic lens barrel 121 are extended, the first imaging device 110 and the second imaging device 120 move toward the sides of the first telescopic lens barrel 111 and the second telescopic lens barrel 121 opposite to the front end sides.

As described above, in the stereo-image taking apparatus 100 according to the first embodiment of the present invention, even in the case of wide-angle range, the distances from the positions of the front-most surfaces of the first telescopic lens barrel 111 and the second telescopic lens barrel 121 to the optically functional surface 131 are the same as those in the case of telephotographic range. Thus, the optically functional surface 131 for splitting imaging light incident on the incident surface 132 does not require a large region.

In other words, in the conventional art, in a semi-reflective mirror for splitting imaging light incident on an incident surface thereof, a very large region which is unnecessary when an image of telephotographic range is taken is required for taking an image of wide-angle range. Thus, as a result, a large-size semi-reflective mirror is required. However, in the stereo-image taking apparatus 100 according to the first embodiment of the present invention, when FIGS. 1 and 2 are compared, a very large-size beam splitter provided for taking an image of wide-angle range is unnecessary, and the prism member 130 which is small in size and has the optically functional surface 131 which is relatively small in size can be used. As a result, the stereo-image taking apparatus 100 also can be decreased in size.

As described above, according to the stereo-image taking apparatus 100 according to the first embodiment of the present invention, the small-sized prism member 130 having the optically functional surface 131 for splitting imaging light from a photographic subject into two portions is included and it is made possible to take both of images of telephotographic range and wide-angle range.

It should be noted that in the present embodiment, as shown in FIGS. 1 and 2, the first telescopic lens barrel 111 and the second telescopic lens barrel 121 are located so as to directly face the first light-exit surface 133 and the second light-exit surface 134, respectively, but the present embodiment is not limited thereto. The first telescopic lens barrel 111 and the second telescopic lens barrel 121 may be located in another arrangement as long as the distance from the optically functional surface 131 to the front-most surface of the first telescopic lens barrel 111 and the distance from the optically functional surface 131 to the front-most surface of the second telescopic lens barrel 121 are constant. For example, the first telescopic lens barrel 111 and the second telescopic lens barrel 121 may be aligned vertically.

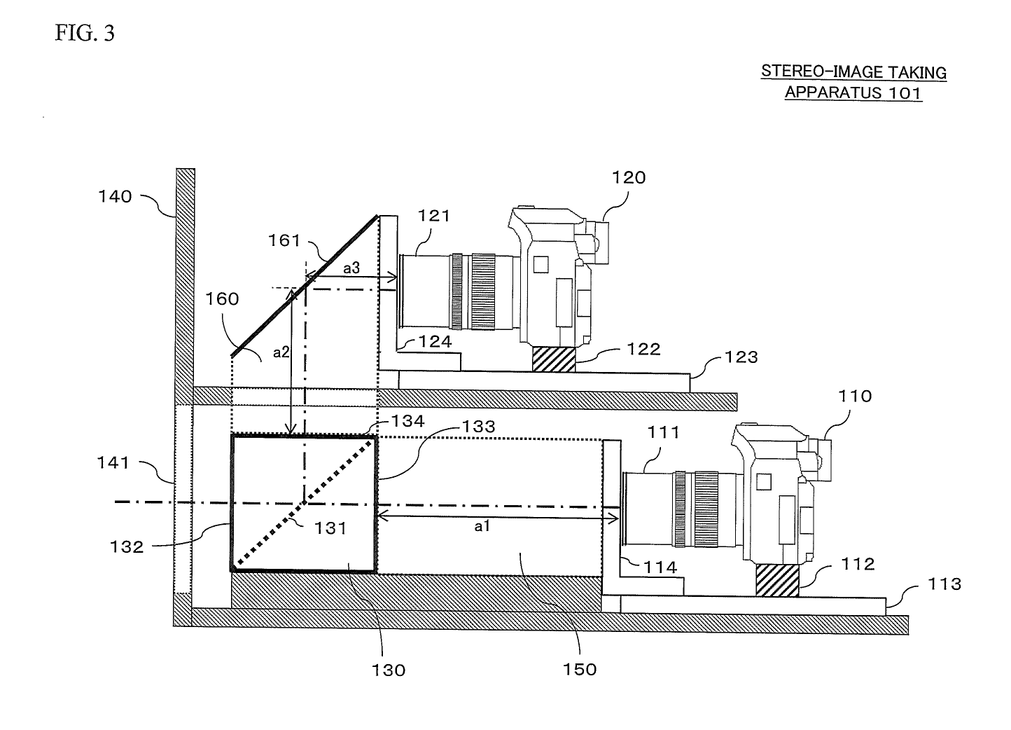

FIG. 3 is a diagram illustrating a situation in which a stereo-image taking apparatus 101 according to the first embodiment of the present invention takes an image of telephotographic range. In the stereo-image taking apparatus 101 shown in FIG. 3, the same components as those of the stereo-image taking apparatus 100 shown in FIG. 1 are designated by the same reference characters, and thus the detailed description thereof is omitted.

In FIG. 3, in the stereo-image taking apparatus 101, the first imaging device 110 and the second imaging device 120 are aligned vertically. Accordingly, the first telescopic lens barrel 111 and the second telescopic lens barrel 121 which are mounted on the first imaging device 110 and the second imaging device 120, respectively, are also aligned vertically.

The imaging light from the photographic subject is incident on the incident surface 132 of the prism member 130, and the first imaging light corresponding to the viewpoint of the left eye passes through the optically functional surface 131 and incident on the first telescopic lens barrel 111 via a first optical path portion 150.

Further, the imaging light from the photographic subject is incident on the incident surface 132 of the prism member 130, and the second imaging light corresponding to the viewpoint of the right eye is reflected by the optically functional surface 131, is also reflected by a reflecting surface 161 via a second optical path portion 160, and then is incident on the second telescopic lens barrel 121.

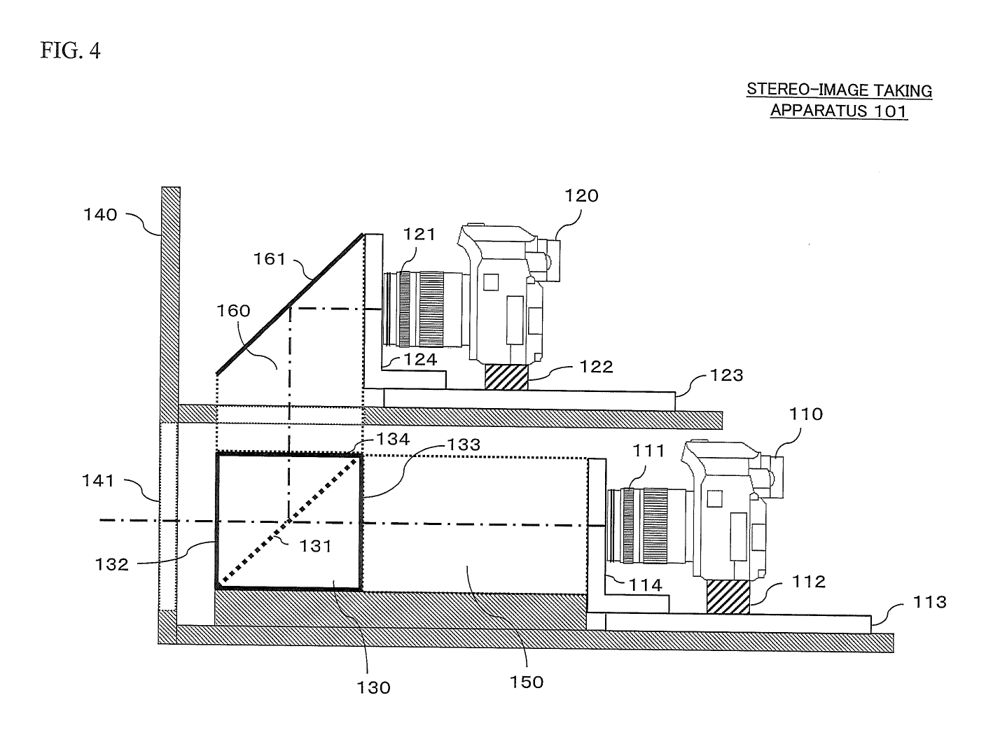

Here, the distance from the first light-exit surface 133 of the prism member 130 to the front-most surface of the first telescopic lens barrel 111 and the distance from the second light-exit surface 134 of the prism member 130 to the front-most surface of the second telescopic lens barrel 121 are constant. Specifically, in FIG. 4, it is satisfied that a1=a2+a3 (hereinafter, referred to as “Equation 1”.

It should be noted that the first optical path portion 150 and the second optical path portion 160 may be different prisms having refractive indexes different from that of the prism member 130, or may be different prisms having the same refractive index as that of the prism member 130. Alternatively, the first optical path portion 150 and the second optical path portion 160 may be a single prism integral with the prism member 130. Still alternatively, the first optical path portion 150 and the second optical path portion 160 are not limited to prisms, and may be, for example, the atmosphere.

The first lens barrel holding member 114 retains the front end of the first telescopic lens barrel 111 such that the front-most surface of the first telescopic lens barrel 111 is fixed at a position where the optical axis adjustment is precisely performed and which satisfies the above “Equation 1”. Similarly, the second lens barrel holding member 124 retains the front end of the second telescopic lens barrel 121 such that the front-most surface of the second telescopic lens barrel 121 is fixed at a position where the optical axis adjustment is precisely performed and which satisfies the above “Equation 1”.

FIG. 4 is a diagram illustrating a situation in which the stereo-image taking apparatus 101 according to the first embodiment of the present invention takes an image of wide-angle range. The difference from the state shown in FIG. 3 is that in order to take an image of wide-angle range, the first telescopic lens barrel 111 and the second telescopic lens barrel 121 are retracted.

When the first telescopic lens barrel 111 is retracted, the first imaging device 110 mounted on the first telescopic lens barrel 111 moves toward the front end side of the first telescopic lens barrel 111 with movement of the first moveable section 112 on the first movement rail 113, since the front end of the first telescopic lens barrel 111 is fixed by the first lens barrel holding member 114.

Further, even when the first imaging device 110 moves as described above, optical axis shift does not occur since the position of the front-most surface of the first telescopic lens barrel 111 with respect to the first light-exit surface 133 is set under the conditions where the optical axis adjustment is precisely performed and the above “Equation 1” is satisfied and the first lens barrel holding member 114 retains the front end of the first telescopic lens barrel 111.

Similarly, when the second telescopic lens barrel 121 is retracted, the second imaging device 120 mounted on the second telescopic lens barrel 121 moves toward the front end side of the second telescopic lens barrel 121 with movement of the second moveable section 122 on the second movement rail 123, since the front end of the second telescopic lens barrel 121 is fixed by the second lens barrel holding member 124.

Further, even when the second imaging device 120 moves as described above, optical axis does not occur since the position of the front-most surface of the second telescopic lens barrel 121 with respect to the second light-exit surface 134 is set under the conditions where the optical axis adjustment is precisely performed and the above “Equation 1” is satisfied and the second lens barrel holding member 124 retains the front end of the second telescopic lens barrel 121.

As described above, according to the stereo-image taking apparatus 101 according to the first embodiment of the present invention, the small-sized prism member 130 having the optically functional surface 131 for splitting imaging light from a photographic subject into two portions is included and it is made possible to take both of images of telephotographic range and wide-angle range. In addition, as compared to the stereo-image taking apparatus 100 described above, the stereo-image taking apparatus 101 is effective when it is desired to decrease a vertical size.

### Second Embodiment

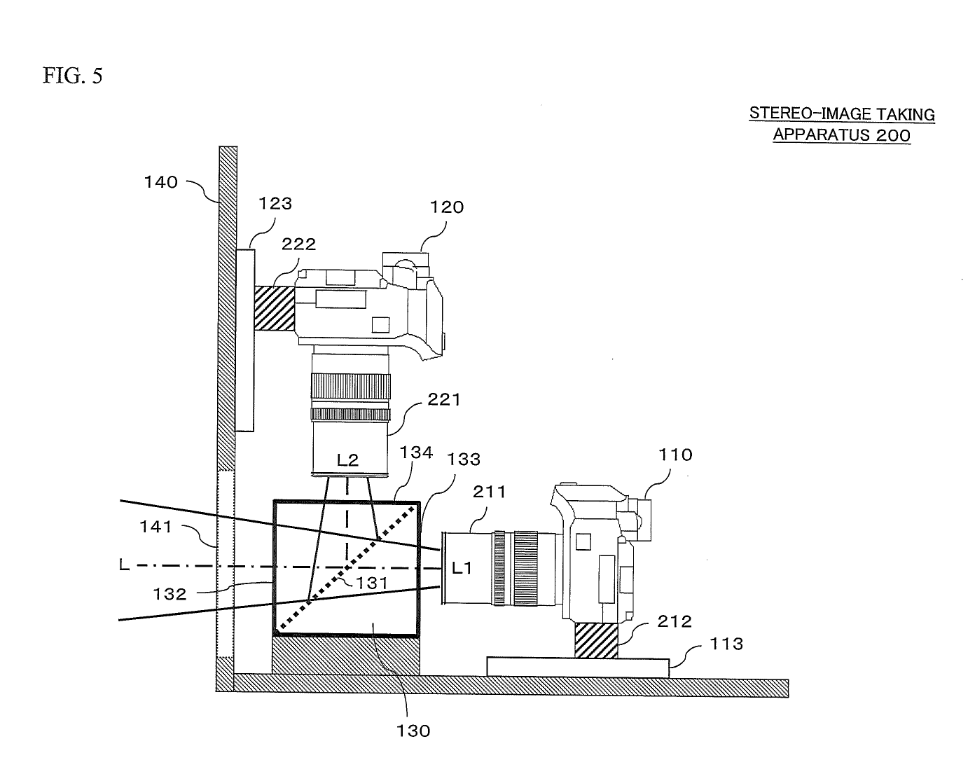

FIG. 5 is a diagram illustrating a situation in which a stereo-image taking apparatus 200 according to a second embodiment of the present invention takes an image of telephotographic range. In FIG. 5, the stereo-image taking apparatus 200 includes a first imaging device 110, a first telescopic lens barrel 211, a second imaging device 120, a second telescopic lens barrel 221, and a prism member 130. It should be noted that in the present embodiment, each of the first telescopic lens barrel 211 and the second telescopic lens barrel 221 is a type in which its front end rotates when the focal distance and focus are adjusted.

Further, in the stereo-image taking apparatus 200 shown in FIG. 5, the same components as those of the stereo-image taking apparatus 100 shown in FIG. 1 are designated by the same reference characters, and thus the detailed description thereof is omitted. Hereinafter, in the present embodiment, the difference from the first embodiment of the present invention will be described in detail.

The stereo-image taking apparatus 200 is covered with the housing 140, and the imaging light from the photographic subject is incident thereon through the front window 141. The prism member 130 has the optically functional surface 131. Of the imaging light incident on the incident surface 132, the first imaging light exists through the first light-exit surface 133, and the second imaging light exists through the second light-exit surface 134. The basic configuration of the stereo-image taking apparatus 200 described above is the same as that of the stereo-image taking apparatus 100, shown in FIG. 1, according to the first embodiment of the present invention.

Further, an optical axis obtained by causing the optical axis L1 of the first telescopic lens barrel 211 to pass through the optically functional surface 131 and an optical axis obtained by bending the optical axis L2 of the second telescopic lens barrel 221 by the optically functional surface 131 are caused to coincide with each other to be an optical axis L as shown in FIG. 5, when seen from the lateral direction of the stereo-image taking apparatus 200. Then, under such precise optical axis adjustment, the position of a front-most surface of the first telescopic lens barrel 211 with respect to the first light-exit surface 133 is set and the position of a front-most surface of the second telescopic lens barrel 221 with respect to the second light-exit surface 134 is set.

However, since each of the first telescopic lens barrel 211 and the second telescopic lens barrel 221 is a type in which its front end rotates when the focal distance and focus are adjusted, the front ends of the first telescopic lens barrel 211 and the second telescopic lens barrel 221 are not retained by the first lens barrel holding member 114 and the second lens barrel holding member 124 in the stereo-image taking apparatus 200, as in the stereo-image taking apparatus 100 according to the first embodiment of the present invention.

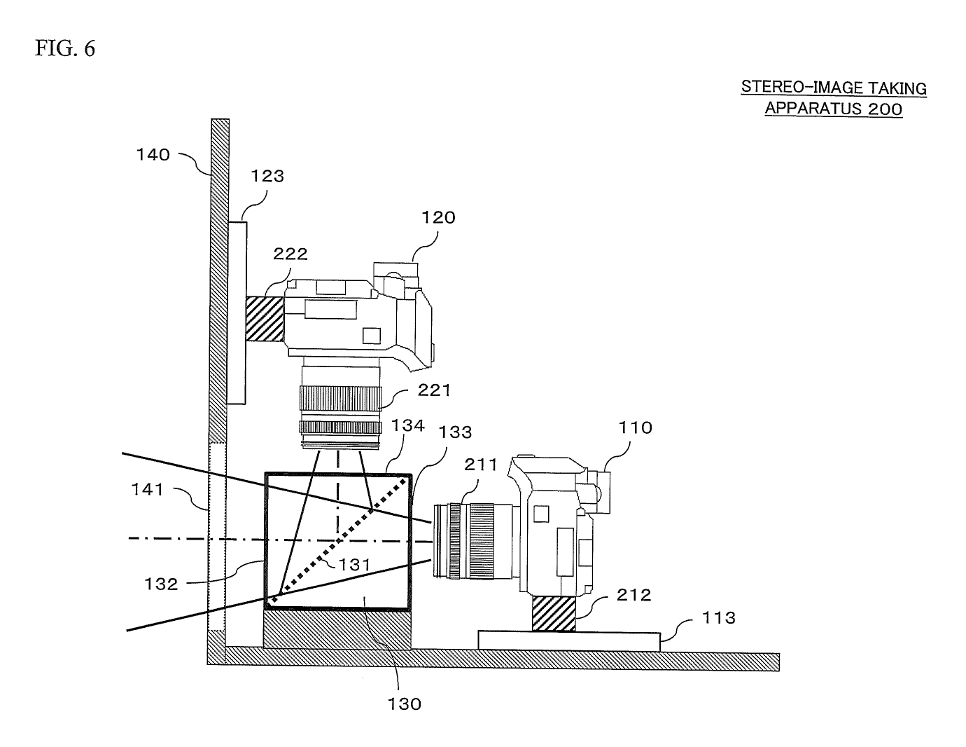

FIG. 6 is a diagram illustrating a situation in which the stereo-image taking apparatus 200 according to the second embodiment of the present invention takes an image of wide-angle range. The difference from the state shown in FIG. 5 is that in order to take an image of wide-angle range, the first telescopic lens barrel 211 and the second telescopic lens barrel 221 are retracted. It should be noted that when the first telescopic lens barrel 211 and the second telescopic lens barrel 221 are retracted, their front ends rotate.

Here, in the stereo-image taking apparatus 200, as described above, under the precise optical axis adjustment, the position of the front-most surface of the first telescopic lens barrel 211 with respect to the optically functional surface 131 is set and the position of the front-most surface of the second telescopic lens barrel 221 with respect to the optically functional surface 131 is set. Even when the first telescopic lens barrel 211 and the second telescopic lens barrel 221 are extended or retracted, the distance from the optically functional surface 131 to the front-most surface of the first telescopic lens barrel 211 and the distance from the optically functional surface 131 to the front-most surface of the second telescopic lens barrel 221 are constant.

In other words, with extension or retraction of the first telescopic lens barrel 211 and the second telescopic lens barrel 221, for example, a control section (not shown) moves the first imaging device 110 and the second imaging device 120.

Specifically, a first moveable section 212 retains the first imaging device 110 and has a mechanism to move on the first movement rail 113. The control section controls the first moveable section 212 so as to move the first imaging device 110 to a position corresponding to the lens length of the first telescopic lens barrel 211.

Similarly, a second moveable section 222 retains the second imaging device 120 and has a mechanism to move on the second movement rail 123. The control section controls the second moveable section 222 so as to move the second imaging device 120 to a position corresponding to the lens length of the second telescopic lens barrel 221.

It should be noted that the control section may control the first moveable section 212 and the second moveable section 222 on the basis of extent of shifting by the first imaging device 110 and the second imaging device 120 corresponding to extension or retraction of the first telescopic lens barrel 211 and the second telescopic lens barrel 221.

Further, a look-up table, which correlates the lens length of the first telescopic lens barrel 211 with the position of the first imaging device 110 corresponding to the lens length and which correlates the lens length of the second telescopic lens barrel 221 with the position of the second imaging device 120 corresponding to the lens length, may previously be recorded in a recoding medium such as a memory. The control section may control the first moveable section 212 and the second moveable section 222 on the basis of the look-up table.

Further, the control section may be included in each of the first moveable section 212 and the second moveable section 222 or in each of the first imaging device 110 and the second imaging device 120, or may have another physical configuration.

As described above, according to the stereo-image taking apparatus 200 according to the second embodiment of the present invention, the small-sized prism member 130 having the optically functional surface 131 for splitting imaging light from a photographic subject into two portions is included and it is made possible to take both of images of telephotographic range and wide-angle range. In addition, holding members for retaining the front ends of the first telescopic lens barrel 211 and the second telescopic lens barrel 221 are unnecessary, and thus the second embodiment is applicable to even cases where the telescopic lens barrels are a type in which its front end rotates or have various sizes.

### Third Embodiment

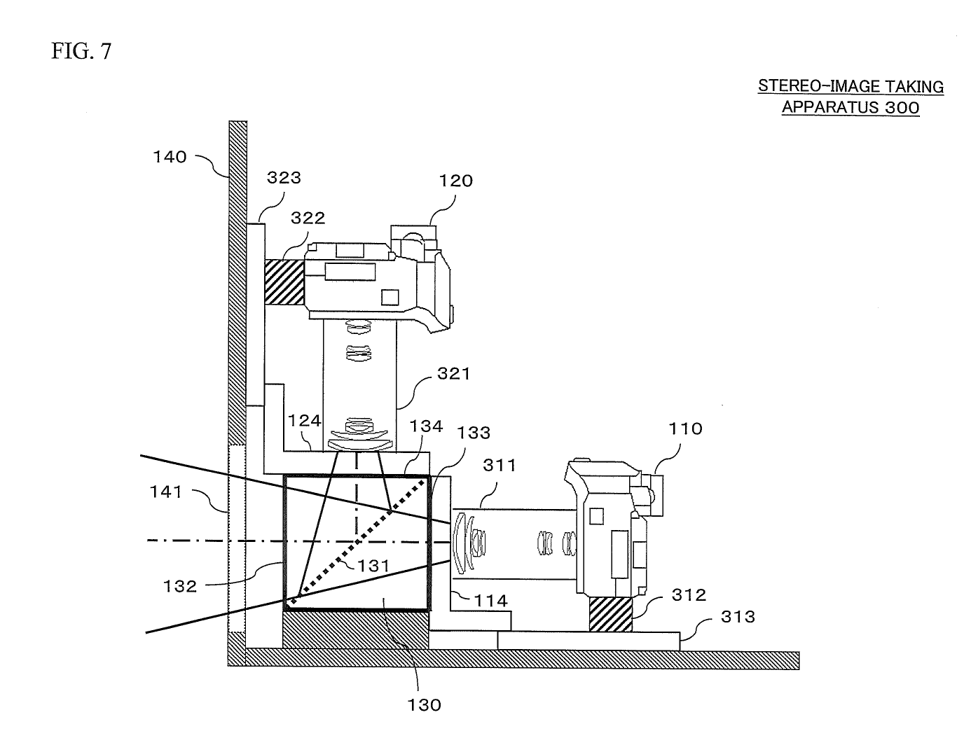

FIG. 7 is a diagram illustrating a stereo-image taking apparatus 300 according to a third embodiment of the present invention. In FIG. 7, the stereo-image taking apparatus 300 includes a first imaging device 110, a first lens barrel 311, a second imaging device 120, a second lens barrel 321, and a prism member 130. It should be noted that in the present embodiment, each of the first lens barrel 311 and the second lens barrel 321 includes a plurality of lens units, and is a type in which the positions of the internal lenses are changed in the optical axis direction when the focal distance and focus are adjusted.

Further, in the stereo-image taking apparatus 200 shown in FIG. 7, the same components as those of the stereo-image taking apparatus 100 shown in FIG. 1 are designated by the same reference characters, and thus the detailed description thereof is omitted. Hereinafter, in the present embodiment, the difference from the first embodiment of the present invention will be described in detail.

The stereo-image taking apparatus 300 is covered with the housing 140, and the imaging light from the photographic subject is incident thereon through the front window 141. The prism member 130 has the optically functional surface 131. Of the imaging light incident on the incident surface 132, the first imaging light exists through the first light-exit surface 133, and the second imaging light exists through the second light-exit surface 134.

The first lens barrel holding member 114 retains a front end of the first lens barrel 311 such that a front-most surface of the first lens barrel 311 is fixed at a position where the optical axis adjustment is precisely performed. Similarly, the second lens barrel holding member 124 retains a front end of the second lens barrel 321 such that a front-most surface of the second lens barrel 321 is fixed at a position where the optical axis adjustment is precisely performed. The basic configuration of the stereo-image taking apparatus 200 described above is the same as that of the stereo-image taking apparatus 100, shown in FIG. 1, according to the first embodiment of the present invention.

In the stereo-image taking apparatus 300, each of the first lens barrel 311 and the second lens barrel 321 does not have telescoping functionality and is characterized in including a plurality of lens units. Thus, a first imaging device holding member 312 which retains the first imaging device 110 and a second imaging device holding member 322 which retains the second imaging device 120 do not have a moveable function and are fixed to a first imaging device holding member base 313 and a second imaging device holding member base 323, respectively.

When the first telescopic lens barrel 111 and the second telescopic lens barrel 121 are extended and retracted as shown in FIGS. 1 and 2 in the first embodiment of the present invention, the lenses of the lens units included in the first lens barrel 311 and the second lens barrel 321 are moved in the stereo-image taking apparatus 300 according to the present embodiment. By so doing, in the stereo-image taking apparatus 300, the focal distance and focus are adjusted, whereby it is made possible to take both of images of telephotographic range and wide-angle range.

As also described in the first embodiment of the present invention, the positional relationships between the first light-exit surface 133 and the second light-exit surface 134 of the prism member 130 and the front-most surfaces of the first lens barrel 311 and the second lens barrel 321 are precisely set. Thus, even when the lenses in the first telescopic lens barrel and the second telescopic lens barrel are moved, optical axis shift does not occur.

As described above, according to the stereo-image taking apparatus 300 according to the third embodiment of the present invention, the small-sized prism member 130 having the optically functional surface 131 for splitting imaging light from a photographic subject into two portions is included and it is made possible to take both of images of telephotographic range and wide-angle range. In addition, since the first imaging device 110 and second imaging device 120 do not move, moveable sections, rails, and the like for moving the first imaging device 110 and the second imaging device 120 are unnecessary. As a result, the stereo-image taking apparatus 300 can be further decreased in size and can be realized at low cost.

It should be noted that in the present invention, the configurations and features of the stereo-image taking apparatuses according to the first to third embodiments described above may be combined as appropriate.

Further, in each embodiment described above, the beam splitter (prism member 130) is used for branching the incident light. However, instead of the beam splitter, a plate-shaped semi-reflective mirror or a right-angled prism having a semi-reflective mirror surface formed in a slope may be used.

Moreover, in the configuration in FIGS. 3 and 4, a member having the reflecting surface 161 used for bending the traveling direction of the second imaging light may be a plate-shaped mirror or a right-angled prism.

The present invention is useable as a stereo 3D imaging apparatus which takes an three-dimensional image, and is useful particularly for a small-sized camera and a video camera which make it possible to take both of images of telephotographic range and wide-angle range.

While the invention has been described in detail, the foregoing description is in all aspects illustrative and not restrictive. It will be understood that numerous other modifications and variations can be devised without departing from the scope of the invention.

What is claimed is:

1. A stereo-image taking apparatus comprising:
an optical element having an optically functional surface passing first imaging light, being a portion of imaging light incident from a photographic-subject thereof, and reflecting second imaging light, being the remaining portion of the incident imaging light;
a first telescopic lens barrel having telescoping functionality, defining a first lens length and a first extension/retraction axis, and constructing the first imaging light into an image;
a second telescopic lens barrel having telescoping functionality, defining a second lens length and a second extension/retraction axis, and constructing the second imaging light into an image;
a first imaging device mounted on the first telescopic lens barrel, for generating a first image on the basis of the first imaging light constructed into an image through the first telescopic lens barrel;
a second imaging device mounted on the second telescopic lens barrel, for generating a second image on the basis of the second imaging light constructed into an image through the second telescopic lens barrel;
a first moveable section causing, in accordance with extension/retraction of the first telescopic lens barrel, the first imaging device to parallel-shift along the first extension/retraction axis; and
a second moveable section causing, in accordance with extension/retraction of the first telescopic lens barrel, the second imaging device to parallel-shift along the second extension/retraction axis.

2. The stereo-image taking apparatus according to claim 1, wherein the length along the optical axis of the first telescopic lens barrel of an optical path from the optically functional surface to a front-most surface of the first telescopic lens barrel and the length along the optical axis of the second telescopic lens barrel of an optical path from the optically functional surface to a front-most surface of the second telescopic lens barrel are uniform.

3. The stereo-image taking apparatus according to claim 2, further comprising:
a first lens barrel holding member fixing the position of the front-most surface of the first telescopic lens barrel; and
a second lens barrel holding member fixing the position of the front-most surface of the second telescopic lens barrel.

4. The stereo-image taking apparatus according to claim 3, wherein:
the first moveable section moves in conjunction with the extension/retraction of the first telescopic lens barrel; and
the second moveable section moves in conjunction with the extension/retraction of the second telescopic lens barrel.

5. The stereo-image taking apparatus according to claim 4, further comprising rails formed along the optical axes of the first and second telescopic lens barrels, respectively; wherein the first and second moveable sections are shiftably carried on the respective rails.

6. The stereo-image taking apparatus according to claim 1, further comprising a control section controlling extent of shifting by the first and second moveable sections; wherein
the control section is configured to control the first moveable section so as to move the first imaging device to a position corresponding to the first lens length, and is configured to control the second moveable section so as to move the second imaging device to a position corresponding to the second lens length.

7. The stereo-image taking apparatus according to claim 6, further comprising a look-up table correlating the first lens length with the first-imaging-device position corresponding to the first lens length, and correlating the second lens length with the second-imaging-device position corresponding to the second lens length; wherein
the control section controls the first and second moveable sections on the basis of the look-up table.
